(19) United States
(12) Patent Application Publication
(10) Pub. No.: US 2006/0090022 A1
(43) Pub. Date: Apr. 27, 2006

(54) Input device for controlling movement in a three-dimensional virtual environment

(75) Inventors: Brian Flynn, Huntsville, AL (US); Kyle Ellison, Huntsville, AL (US); Eric Grigorian, Huntsville, AL (US)

Correspondence Address: BROMBERG & SUNSTEIN LLP, 125 SUMMER STREET, BOSTON, MA, 02110-1618, US

(73) Assignee: Intergraph Hardware Technologies Company, Las Vegas, NV (US)

(21) Appl. No.: 10/972,072

(22) Filed: Oct. 22, 2004

(51) Int. Cl. G06F 13/42

(52) U.S. Cl. 710/105

(57) ABSTRACT

A user-controlled input device for use with a computer system is disclosed. The user controlled input device controls at least three-dimensional movement in a three-dimensional virtual space defined by a three axis coordinate system. The device includes a controller body and at least a pressure controlled button joystick coupled to the controller body. Displacement of the button joystick in a first direction translates into directional movement at least about a first axis. The button joystick includes a force sensor wherein an output signal is produced by the button joystick that is proportional to the force placed on the button joystick. The output signal is translated by a computer program into a rate of motion that is proportional to the pressure that is supplied by the user of the input device. In certain embodiments, a second button joystick is coupled to the controller body to control directional movement about a second and a third axis. In such an embodiment, each edge of the force controller controls movement in a different direction. For example, the user can move the cursor using only a single button in both the x and y directions in a three-dimensional virtual space (x,y,z).

### TECHNICAL FIELD AND BACKGROUND ART

The present invention relates to user input devices and more specifically to user input devices for controlling movement in a three-dimensional virtual space such as those used in photogrammetry systems.

Photogrammetry implies that the dimensions of objects are measured without the objects physically being touched. Stated differently photogrammetry is the remote sensing of objects within an image. In photogrammetry, the physical measurements of an object are determined from actual known distances. In certain prior art systems, sequential images of aerial photographs are overlapped to create a stereo view of a geographical location. The known view allows height information to be extracted from the images given distances between locations. Photogrammetry information can be used with a computer system to create a virtual three-dimensional environment.

A computer operator can cause a computer system to produce the virtual three-dimensional environment of the image data on a display device. The computer operator can then virtually move through the three-dimensional environment as displayed and extract additional information from the data set. For example, the computer system may display a three-dimensional environment of a city. A building within the three-dimensional environment may be rendered, and therefore, the height of the building relative to the other buildings may be known. However, the height of the building from the street level may not be known. By entering the three-dimensional environment, a user can mark the location of the street level using a user input device and then can move in the z direction (assuming a standard x,y,z coordinate system) to determine the height of the building relative to the street level.

It is known in the prior art to have a three-dimensional controller for use with photogrammetry systems, such as the SoftMouse device 10 made by the Immersion Corporation. Such controllers operate with a computer system and allow a user to view and measure three-dimensional objects or terrain on a two dimensional display device using photogrammes (digitized photographs or imagery stored electronically taken by a camera or scanner). The measurements of objects or terrain that are taken using the three-dimensional controller during the viewing process can be used to provide topographical information for maps or coordinates of objects within the image.

The SoftMouse device 10 as shown in FIG. 1 includes multiple types of inputs including optical encoders 15, trigger buttons 16, and function keys 17. In the SoftMouse device, the optical encoders 15 allow a user to control the x, y, and z positions of a cursor within the image that is being displayed on the display device. The trigger buttons 16 allow the user to trigger data collection (measurements) and the function keys 17 are used to set parameters and change operational modes.

The optical encoders 15 of the SoftMouse design 10 are used for controlling the x and y positions within the displayed image are placed on the underside of the mouse 10. As the mouse 10 is physically moved across a surface 20 in the x and y directions, the x and y positions within the displayed three-dimensional image change. Thus, if a user wishes to move through the image, the user must move the mouse 10 in the desired directions and the user cannot continuously roam through the image without continuously moving the mouse.

### SUMMARY OF THE INVENTION

A user-controlled input device for use with a computer system is disclosed. The user controlled input device controls at least three-dimensional movement in a three-dimensional virtual space defined by a three axis coordinate system. The device includes a controller body and at least a force controller, such as a button joystick coupled to the controller body. Displacement of the force controller in a first direction translates into directional movement at least about a first axis. The force controller includes a force sensor wherein an output signal is produced by the force controller that is proportional to the force placed on the force controller. The output signal is translated by a computer program into a rate of motion that is proportional to the pressure that is supplied by the user of the input device. In certain embodiments, a second force controller is coupled to the controller body to control directional movement about a second and a third axis. In such an embodiment, each edge of the force controller controls movement in a different direction. For example, the user can move the cursor using only a single button in both the x and y directions in a three-dimensional virtual space (x,y,z). In other embodiments, each force controller controls only movement relative to a single axis, and the user input device also includes a rotational wheel that when rotated controls motion in the third dimension. The user input device need not be physically moved across a surface in order to obtain three-dimensional movement within the three-dimensional space.

By continually pressing on either one or both of the force controllers, movement will continue in an axial direction controlled by the force controller. In various embodiments, other buttons may also be included which are not force controllers. These additional buttons may be user assigned buttons and may be assigned to various functions of the computer program. For example, the additional buttons may be two state on-off buttons.

In certain embodiments, an optical sensor is coupled to the controller body allowing control of a program control cursor over a two dimensional space superimposed on the three-dimensional space. The two dimensional space is the control space and includes one or more menus that are user selectable using the control cursor. The optical sensors require the user input device to be physically moved across a surface in order for movement to occur in the two-dimensional space.

The controller body of the user input device may be ergonomically shaped to reduce stress on hands and wrists and to reduce carpal-tunnel syndrome. The controller body is U-shaped allowing the user to place both hands on the controller and to have his thumbs positioned over the force controllers, while the user's palms wrap around the controller body and the user's fingers are positioned on indented buttons.

The computer system may include both a computer and a display device, as well as, a computer program that can generate and render a three-dimensional virtual space on the display device. The computer program may be a computer program used for photogrammetry. The data that is used to represent the three-dimensional space may be stored in associated memory in a database. In other embodiments, the user input device may be used for three dimensional video games or for movement through a three dimensional image such as a medical scan.

### BRIEF DESCRIPTION OF THE DRAWINGS

The foregoing features of the invention will be more readily understood by reference to the following detailed description, taken with reference to the accompanying drawings, in which:

FIG. 1 is an image of a prior art three-dimensional input device;

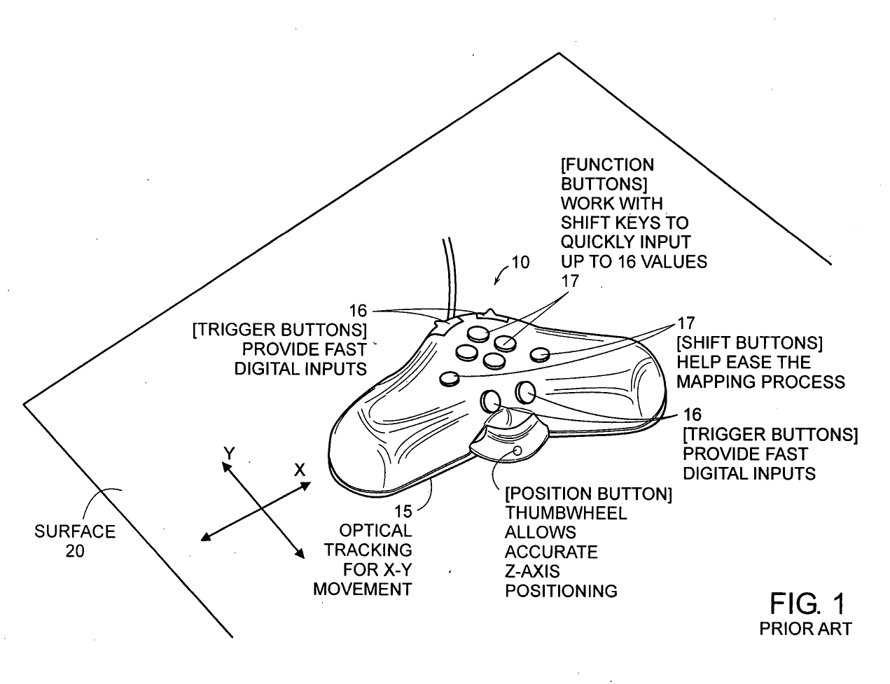

FIG. 2 is a diagram showing a first environment for the invention;

FIG. 3 shows a first embodiment of the user input device;

FIG. 4 is a representation of the three-dimensional coordinate system;

FIG. 5 shows a side view of one of the force-controlled button joysticks;

FIG. 6 is a flow chart showing a method for moving through a three-dimensional virtual space defined by a computer system using a user input device without moving the device; and

FIG. 7 is a side view of the user input device showing the ergonomic features of one embodiment.

### DETAILED DESCRIPTION OF SPECIFIC EMBODIMENTS

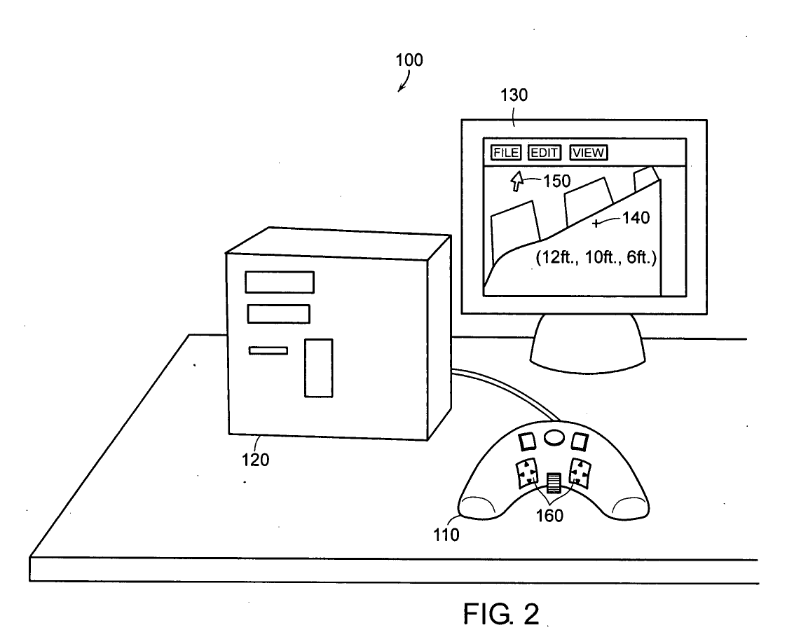

FIG. 2 is a diagram showing a first environment 100 for the invention. The user input device 110 works in conjunction with a computer system 120 running a computer program. The computer program interprets data stored in memory and causes the data to be rendered as a virtual three-dimensional environment on a display device 130. The computer program causes one or more cursors to be displayed. The first cursor 140 is used as a guide for determining position within the 3-dimensional space. For example as shown in the FIG. 2, the cursor is rendered at a position within an x,y,z coordinate system (12 ft., 10 ft., 6 ft.). Thus, the first cursor 140 operates within the three-dimensional space. A second cursor 150 may also be rendered on the display device for controlling the program. This cursor 150 is shown as an arrow on the display device. The second cursor 150 operates in a two-dimensional space and allows a user to point to and select a function of the computer program. The two dimensional space within which the second cursor is present is not part of the three-dimensional space of the first cursor.

The user of the system can control both cursors using the user input device 110. The user input device includes a plurality of user assignable buttons and a pair of force-controlled joystick buttons 160. The force-controlled joystick buttons may be the model 462 as manufactured by Measurement Systems, Inc. Similarly, other force-controlled controllers may be substituted.

In a different embodiment, the user input device 110 only controls the first cursor 140 within the three dimensional space while a secondary input device, such as a mouse or a trackball (not shown) is used to control the second cursor 150 in the two-dimensional control space.

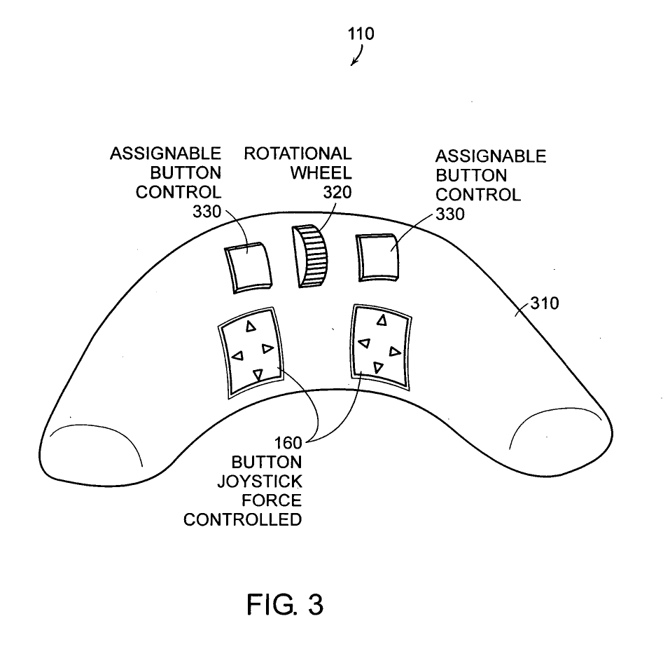

FIG. 3 shows a first embodiment of the user input device. The user input device is ergonomically shaped to allow a user to place both hands on the input device simultaneously. The user's thumbs are placed on top of the force-controlled joystick buttons while the user's palms wrap around the exterior 310 of the controller and the user's fingers are aligned with a plurality of buttons (not shown) which are indented to identify a position for each finger. As a result, in one embodiment there are eight buttons, each having an indentation for each of the user's eight fingers. The user input device may also includes a rotating wheel 320. The rotating wheel 320 may be turned by the user, using either thumb. The rotating wheel is used to control an incremental input, such as movement in the z-direction.

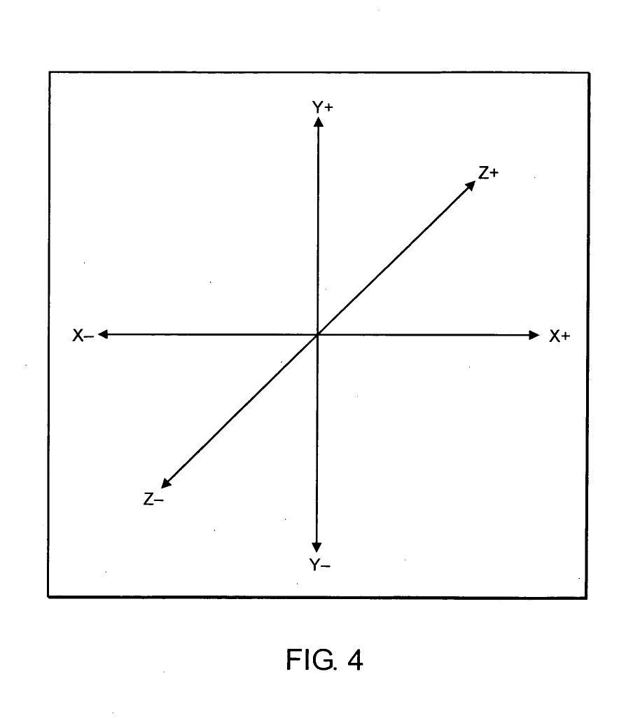

The force-controlled button joysticks 160 produce an analog output signal that is proportional to the pressure that is placed on the button 160. In one embodiment, the button 160 can be pressed at each of its four sides. A piezo-resistive strain gauge resides at each side and produces an output signal when an edge of the button is depressed. Thus, the button can be used to control position of the cursor within two dimensions of the three-dimensional virtual space (e.g. the positive and negative x directions and the positive and negative y directions). As shown in the figure, there are two separate buttons 160, therefore all three-dimensions can be controlled with the two buttons. In such a configuration, the first button controls the x and y directions and the second button controls the z direction. In this embodiment, only two of the four sides of the second button produce an output signal. In other embodiments four dimensions could be controlled with the two joystick buttons (x,y,z, t) wherein each joystick button controls two dimensions. (Both positive and negative directional movement). In still further embodiments, each of the joystick buttons control only a single direction. For example, the right button may control the x direction and the left button may control the y direction. The z direction would be controlled by another control, such as, a rotational wheel. Thus, a user could move continuously through the x-y plane and would only have to stop or slow movement, if movement in the z direction is desired. FIG. 4 shows the coordinate system of the three-dimensional space. The user input device also includes a plurality of user assignable buttons 330 that can be assigned to various functions of the computer program.

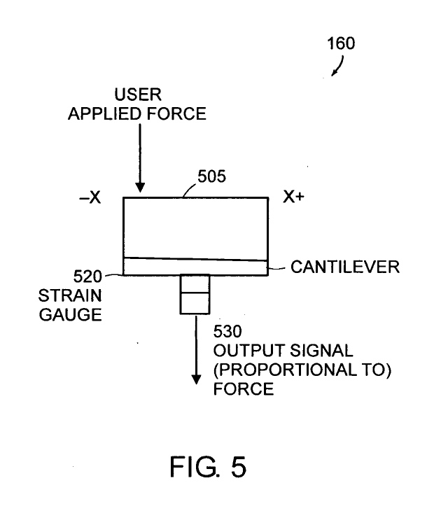

FIG. 5 shows a side view of one of the force-controlled button joysticks 160. The button can be pressed by a user along one edge of its top 505. The depression of the button in a direction causes the cantilevered strain gauge 520 to produce an output signal 530 that is proportional to the applied force. This signal is provided by the user input device to the computer system. A computer program operating on the computer system receives this input signal, which is converted to a stream of digital values. The signal may be converted by the input device or by the computer system. In another embodiment, the strain gauge 520 is a digital device producing a digital output. The values are then used by the computer program to determine the speed of movement within the three-dimensional virtual space in the direction associated with the edge of the button that is depressed. For example, if the button controls the movement in the x direction, the depression of the left side of the button causes the cursor to move through the three-dimensional space in the negative x direction. Thus, the value of x would decrease, while y and z would remain the same (assuming that no other button or control is operated simultaneously). As more force is applied to the button, the strain gauge 520 will produce a larger output signal and the computer program will cause the rate of movement in the negative x direction to increase. When the button 160 is not depressed, the rate of movement is zero, and therefore as the user applies more pressure the rate increases to a maximum rate which is equivalent to the maximum amount of deflection for the button.

When both force-controlled button joysticks are used, the user-input device can be used to roam through the three-dimensional virtual environment at either a fixed or variable rate of speed depending on the pressure applied to each of the controllers. If a user desires to move at a fixed rate of speed in a particular direction the user will apply pressure to the controller until the rate of speed is set, and then the user will select a locking button. The locking button acts like an automatic cruise control button on a car. In such a configuration, each force-controlled button joystick is used to control at least one direction. As a result, a user may move the cursor in the x-y plane, the x-z plane or the y-z plane at a constant rate.

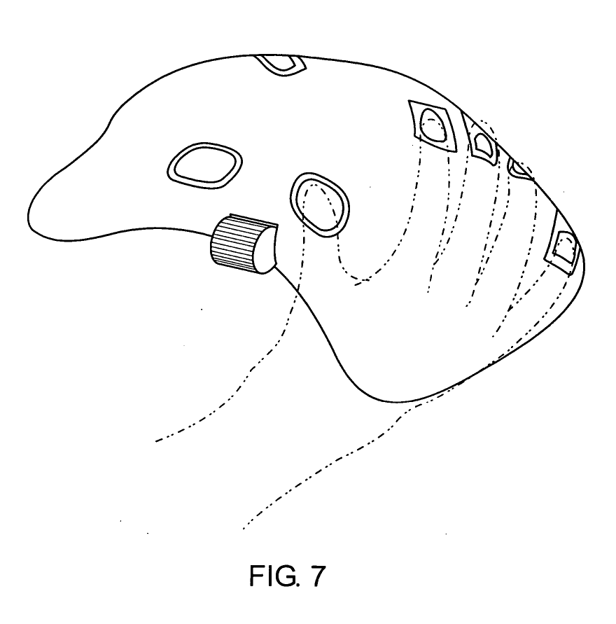

Movement through the three-dimensional virtual environment is accomplished without moving the user-input device. The user-input device can remain stationary or mounted to a surface and a user can roam through the three-dimensional space using the force-controlled button joystick. The user input device as shown in FIGS. 3 and 7 may also include an optical tracking sensor on the surface-contracting side of the user input device. The optical tracking sensor senses physical movement of the user-input device across the surface. The signal that is produced by the optical hacking sensor is provided to the computer program. The output of the sensor is used to control movements of the cursor within the 2-dimensional control space. The control space allows a user to change parameters and settings for the computer program.

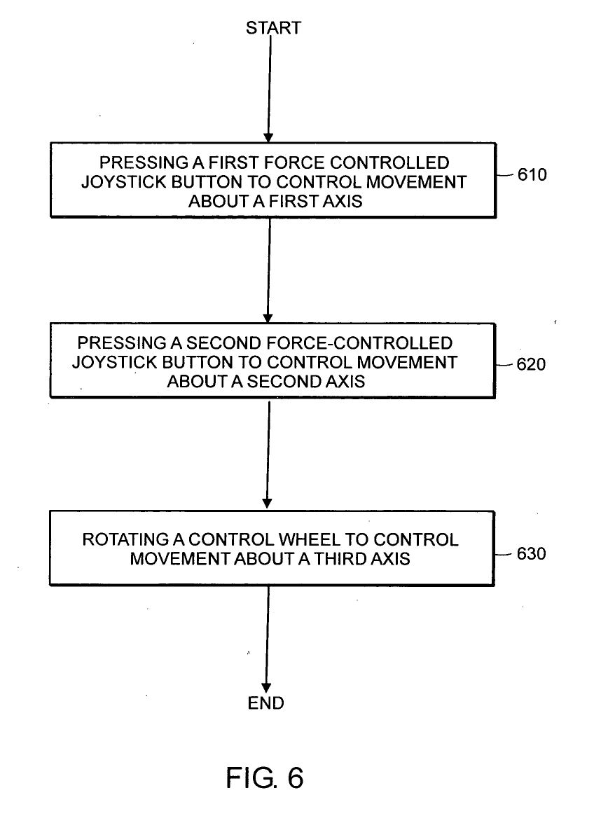

FIG. 6 is a flow chart showing a method for moving through a three-dimensional virtual space defined by a computer system using a user input device without moving the device. A user of the computer system first activates the computer program which displays the three-dimensional virtual space on a display device, and the user accesses the user input device. The user then places his hands on the ergonomically shaped user input device, aligning his thumbs with the force-controlled button joysticks as shown in FIG. 7. The user's fingers are each positioned on an indented button. The user can then press one of the force-controlled joystick buttons on the user input device, wherein the pressure placed on the button by the user translates into speed of movement of a cursor in a first direction defined by a first axis in the three-dimensional space (610). In the neutral position, prior to the user depressing the joystick button, the cursor remains stationary. When the user removes his finger from the button, the cursor is again stationary. As a result, the button returns to its neutral position, which corresponds with the cursor being stationary within the three-dimensional environment. The user may also press on a second force-controlled button joystick, wherein the pressure placed on the joystick button by the user translates into speed of movement of the cursor in a second direction defined by a second axis (620). Thus, a user may move in two dimensions within the three-dimensional space (e.g. along the x-y plane). The user can also rotate a rotating controller wheel. The rotating controller wheel defines movement of the cursor in a third dimension (e.g. the positive and negative z direction) (630). By applying even pressure to the force controlled joystick buttons, the user can roam through the three-dimensional space at a fixed rate or variable rate. For example, if the user provides more force to the button controlling movement in the y direction than to the button controlling movement in the x direction, for each time period that the buttons are held in that position, the cursor will move a greater distance in the y direction as compared to the x direction.

Additional buttons are provided for various system applications and are assignable. One of the buttons can be assigned to lock the rate of speed in a particular direction so that the user does not need to hold their fingers at the exact pressure level to maintain a constant rate of movement.

It should be understood by one of ordinary skill in the art that the user input device may be used for any of a variety of three dimensional computer applications including, but not limited to: photogrammetry, medical imaging and diagnostics, and 3-D gaming.

The present invention as expressed above may be embodied in other specific forms without departing from the true scope of the invention. The described embodiments are to be considered in all respects only as illustrative and not restrictive.

What is claimed is:

1. A user-controlled input device for use with a computer system wherein the user controlled input device controls at least three-dimensional movement in a three-dimensional virtual space defined by a three axis coordinate system, the device comprising:
a controller body;
a joystick button coupled to the controller body wherein displacement of the joystick button in a first direction translates into directional movement at least about a first axis.

2. A user-controlled input device for use with a computer system wherein the joystick button includes a force sensor wherein an output signal is produced by the joystick button that is proportional to the force placed on the joystick button.

3. The user controller according to claim 2, wherein a second force controller is coupled to the controller body to control directional movement about a second and a third axis.

4. The user controller according to claim 2, further comprising:
a rotating controller coupled to the controller body wherein rotation of the rotating controller by a user controls movement along a second axis.

5. The user controlled input device for a computer system according to claim 2,
wherein physical movement of the controller body is not required for obtaining movement in the three-dimensional virtual space.

6. The user-controlled input device for a computer system according to claim 2, further comprising:
an optical sensor coupled to the controller body allowing control of a program control cursor over a two dimensional space that is superimposed on the three-dimensional space.

7. The user-controlled input device for use with a computer system according to claim 2, wherein the input device does not include a digitizer.

8. The user-controlled input device for use with a computer system according to claim 2, wherein by continually pressing on either one or both of the joystick buttons movement will continue in an axial direction controlled by the joystick button.

9. The user controlled input device including one or more on-off buttons.

10. The user controlled input device according to claim 9 wherein the buttons are user-programmable.

11. The user controlled input device according to claim 2 wherein based upon the displacement of the joystick button a voltage signal is output.

12. A method for moving through a three-dimensional virtual space defined by a computer system using a user input device without moving the device, the method comprising:
pressing one of a plurality of joystick buttons on the user input device, wherein the pressure placed on the joystick button by the user translates into speed of movement of a cursor in a first direction defined by a first axis;
pressing on a second one of a plurality of joystick buttons on the user input device, wherein the pressure placed on the joystick button by the user translates into speed of movement of the cursor in a second direction defined by a second axis; and
adjusting a rotating controller on the user input device to define movement of the cursor in a third direction defined by a third axis;
wherein the first, second, and third axes are all perpendicular.

13. The method according to claim 12 wherein each of the plurality of joystick buttons is pressed at the same time causing the cursor to move diagonally through the three-dimensional virtual space.

14. The method according to claim 12 wherein the rotating controller is adjusted at the same time that one of the joystick buttons is depressed causing the cursor to move diagonally through the three-dimensional virtual space.

15. The method according to claim 12, wherein the user input device rests on a surface and the user input device is not physically moved across the surface in order for movement to occur in the three-dimensional virtual space.

16. A system for moving through a virtual three-dimensional space wherein position within the three-dimensional is referenced relative to a coordinate system defined by three perpendicular axes, the system comprising:
a computer executing a computer program, the computer program defining the virtual three-dimensional space, the computer program producing a cursor on a display device defining a position within the three-dimensional space;
a user input device having a plurality of joystick buttons, each joystick button capable of being depressed by a user, wherein displacement of the joystick button by the user is translated into a displacement signal to the computer and which causes the computer program to move the cursor in a direction parallel to one of the axes within the three-dimensional space;
wherein based upon the displacement signal the computer program will cause the rate of movement of the cursor to be proportional to the displacement signal.

17. A user-controlled input device for use with a computer system, the device comprising:
a controller body;
a force controller coupled to the controller body wherein displacement of the force controller creates a first output signal that is used by the computer system to move a cursor in a first direction;
wherein physical movement of the controller body is not required for producing the first output signal.

18. The user-controlled input device according to claim 17 further including:
a second force controller coupled to the controller body wherein displacement of the second force controller creates a second output signal that is used by the computer system to move the cursor in a direction different from the first direction.

19. The user-controlled input device according to claim 17 further comprising:
a rotating controller coupled to the controller body wherein rotation of the rotating controller creates a third output signal for moving the cursor in a direction different from the first and second directions;

20. A system for moving through a virtual three-dimensional space wherein position within the three-dimensional space is referenced relative to a coordinate system defined by three axes, the system comprising:
a computer executing a computer program, the computer program defining the virtual three-dimensional space, the computer program producing a cursor on a display device defining a position within the three-dimensional space;
a user input device having a joystick button capable of being depressed by a user, wherein displacement of the joystick button by the user is translated into a displacement signal to the computer and which causes the computer program to move the cursor in a direction parallel to one the axes.

21. The system according to claim 20, wherein based upon the displacement signal the computer program will cause the rate of movement of the cursor to be proportional to the displacement signal.

22. The system according to claim 20 further including:
a display device for displaying the three-dimensional space and the cursor.

23. The system according to claim 22 wherein the computer system produces controls on the display device and wherein the user input device further includes a sensor for sensing physical movement of the user input device over a surface, the sensor sends a control signal to the computer for controlling movement of a second cursor based on the physical movement.

24. The user-controlled input device according to claim 3, wherein the device is ergonomically shaped for two-handed use.

25. The user-controlled input device according to claim 24, wherein the device includes a plurality of buttons that are positioned on the device so that a user's fingers reside over the buttons while each of the user's thumbs resides on a button joystick.

26. The user-controlled input device according to claim 25 wherein the plurality of buttons includes an indentation sized for a user's finger.

27. The user-controlled input device according to claim 2 wherein the first button joystick further controls movement about a second axis.

28. The user-controlled input device according to claim 2 wherein a second button joystick is coupled to the controller body to control directional movement about a second axis.

29. The user controlled input device according to claim 2 wherein a second button joystick is coupled to the controller body and both button joysticks include a force sensor wherein an output signal is produced by the button joystick that is proportional to the force placed on the button joystick.
